(19) United States
(12) Patent Application Publication
(10) Pub. No.: US 2022/0148489 A1
(43) Pub. Date: May 12, 2022

(54) A DISPLAY DEVICE

(71) Applicant: Hewlett-Packard Development Company, L.P., Spring, TX (US)

(72) Inventors: Poying Chih, Taipei City (TW); Wen Shih Chen, Taipei City (TW)

(73) Assignee: Hewlett-Packard Development Company, L.P., Spring, TX (US)

(21) Appl. No.: 17/414,360

(22) PCT Filed: Jul. 29, 2019
(86) PCT No.: PCT/US2019/043959

§ 371 Date: Jun. 16, 2021

(51) Int. Cl. G09G 3/20

(52) U.S. Cl. CPC G09G 3/2096; G09G 2360/08; G09G 2370/12; G09G 2370/04; G09G 2370/22

(57) ABSTRACT

Examples of a display device with a removably coupled discrete graphics processing unit are described. In an example, the display device includes control circuitry to control the operation of the display device. The display device may further include a graphics interface. The graphics interface is to electrically and removably couple a discrete graphics processing unit (dGPU) to the control circuitry. The dGPU may generate processed display signals based on source display instructions received from a host computing system. The host computing system is any system operating independently with respect to the display device. In one example, visual information is rendered onto a display panel based on the processed display signal.

### BACKGROUND

A display device is an output device for rendering visual information. The information rendered on the display device is based on output signals which may be generated by a computing system, which is externally coupled and operates independently from the display device. Examples of such a display device include display monitors coupled to computing systems. Generally, computing systems may include a Graphics Processing Unit (GPU). A GPU may either be integrated within the motherboard of the computing systems or may be a discrete GPU in the form an expansion card/graphic card which may be fitted into an expansion slot on the motherboard of the computing system.

### BRIEF DESCRIPTION OF THE DRAWINGS

The following detailed description references the drawings, wherein:

FIG. 1 is a block diagram of an example display device;

FIG. 2 is a block diagram of an example computing environment implementing a display device coupled to a host computing system;

FIG. 3 is a flowchart of an example method implementing by an example display device; and

FIG. 4 is a block diagram of another example of a display device with a removably coupled discrete graphics processing unit.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A display device is an output device for rendering various types of content for example, images, text, and videos. The content rendered onto the display device is based on output signals which may be generated by a computing system, which is externally coupled. The computing system thus coupled operates independently from the display device. Generally, computing systems may include a Graphics Processing Unit (GPU). A GPU may be considered as a programmable logic circuit which may be specialized for performing display related processing. In operation, the central processing unit (CPU) of a computing system may provide one or more display instructions pertaining to the content which is to be rendered. The display instructions may be generated as any instructions which are generated by the CPU based on which visual content is to be rendered. Such display instructions are processed by the GPU to render the corresponding content onto the display device.

The GPU may be integrated within the motherboard of the computing systems. Such GPUs uses the memory of the computing device for processing image related data, and subsequently generate display signals for the display device. Another type of GPUs includes discrete GPUs. The discrete Graphics Processing Units, or dGPU, are in the form an expansion card/graphic card which may be fitted into an expansion slot provided on the motherboard of the independently operating and externally coupled computing system. In this case, the graphic processing capabilities of the computing system may be upgraded by replacing a previously existing dGPU with a more recent and advanced dGPU. In cases where multiple expansion slots are present on the motherboard, additional dGPU may also be added to enhance the computational capabilities of the computing systems. This provides flexibility as any dGPU may be replaced, as and when desired by the user.

Although, upgrading processing capabilities of the computing system (by either replacing or adding dGPU) is achievable in computing systems with standard form-factor, the same may not be possible for small form-factor personal computers. Small form-factor computing systems, such as mini PCs, when connected with a display device provide computing systems or desktops with a smaller footprint in comparison to the standard desktop computers. Such mini PCs are externally coupled to a display device onto which the output is rendered.

Such small form-factor computing systems (or mini PCs) are generally provided with an integrated GPU which may not be replaceable. For such mini PCs, upgrading the hardware for enhanced graphical processing may not be possible owing to the size and space limitations that such mini PCs may pose. To this end, the mini PCs may be coupled to an external GPU (eGPU) module. The eGPU module comprises a dedicated GPU, and may be connected between the mini PCs and the display device. In operation, the eGPU module supplements the graphical processing capabilities of the mini PCs.

Although the graphical processing capabilities of host computing systems may be enhanced, doing so may entail obtaining, setting up, and connecting an eGPU to the mini PCs. More number of components results in issues pertaining to cabling, organizing and space, thereby negating the compactness related benefits of such mini PCs.

Examples of display device which permits a discrete graphical processing unit (dGPU) to be removably coupled with control circuitry of the display device, are described. The dGPU may be removably coupled (or installed) within the display device through a graphics interface. The example display device may be used either without the dGPU (i.e., in instances when the dGPU is not installed) when coupled with a host computing system. The host computing system is an externally coupled system which operates independently from the example display device. Alternatively, in cases where the host computing system is to be used for application involving intensive graphical processing, a dGPU may be installed within the display device. In case any different dGPU with more advanced hardware specification is available, a previously available dGPU may be removed and the different dGPU may be installed.

In operation, the control circuity of the display device is to receive one or more source display instructions from a host computing system connected with the example display device which includes a removably coupled dGPU. The dGPU may, thereafter, process source display instructions, provided by the externally coupled host computing system, to generate processed display signals. The processed display signals may then be used for generating and rendering content onto the display panel of the display device. The resulting display device provided with the removably coupled dGPU may enable enhanced graphical processing when compared with the graphical processing capabilities of the host computing system. Furthermore, such an enhancement of the graphical processing capabilities may be achieved without using an eGPU modules.

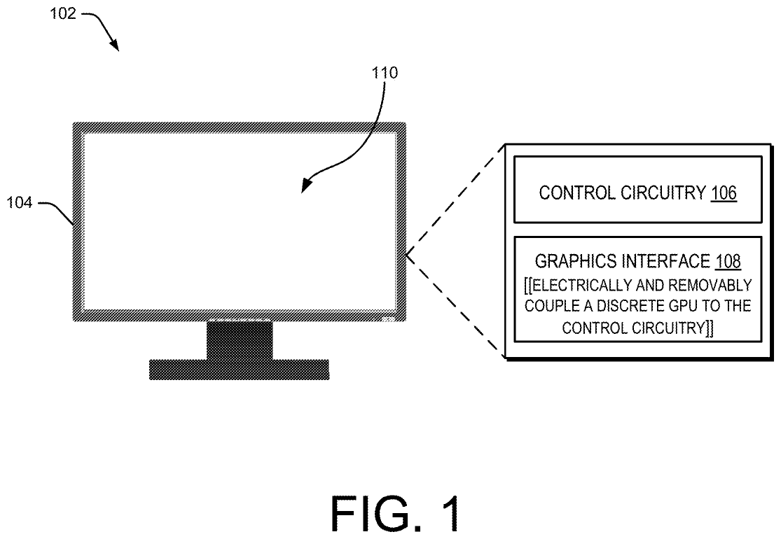

In an example, the coupling between the display device and the externally coupled host computing system may be implemented through a high-speed interface which enables transfer of source display instructions from the host computing system to the example display device. Examples of such an interface include, but are not limited to, Thunderbolt™ 3 interface. These and other examples are provided in further detail in conjunction with FIGS. 1-4.

FIG. 1 provides an illustration of an example display device 102. The display device 102 as per the present example includes, but is not limited to, a display monitor, display devices such as LCD displays, LED displays, Plasma Displays, OLED displays, or a digital projector. It may be noted that other types of display device 102 would also fall within the scope of the present subject matter. The present figure is described with respect to one or more components of the display device 102, which are coupled to each other. It may be noted that the term ‘coupling’ or ‘coupled’ may refer to the components within the display device 102 to be in electrical communication with each other. The coupling may be such that the components of the display device 102 may be directly connected or may be indirectly connected, without deviating from the scope of the present subject matter.

Continuing with the present example, the display device 102 further includes a housing 104 which may securely enclose other components of the display device 102. In the present example, the display device 102 includes control circuitry 106 and a graphics interface 108. The control circuitry 106 may be such that it may include other components that may be utilized for controlling the operation of the display device 102. Such components may be hardware-based elements, such as integrated circuits, or may be include software elements, such as firmware. In another example, the control circuitry 106 may include an interface port through which the display device 102 is to couple with an externally coupled host computing system (not shown in FIG. 1). The externally coupled host computing system operates independently from the display device 102. In such a case, a corresponding interface port may also be provided on the host computing system. In another example, the control circuitry 106 may be a display motherboard of the display device 102.

The graphics interface 108 is further coupled to the control circuitry 106 and provides a mechanism for removably coupling a discrete graphical processing unit (not shown in FIG. 1) with the control circuitry 106 of the display device 102. In an example, the graphics interface 108 may include slots within the control circuitry 106 within which a dGPU is positioned into and installed. The dGPU when positioned within the slots is electrically coupled with the control circuitry 106. It may be that the example display device 102 may operate either with or without the dGPU being removably coupled within the display device 102.

The graphics interface 108, in turn, is further coupled with the display panel 110. The display panel 110 may be implemented using one of a variety of flat-panel display such as an LED panel or LCD panel. In operation, the control circuitry 106 of the display device 102 is to obtain source display instructions from an externally coupled host computing system (not shown in FIG. 1) through an interface. The source display instructions may then be processed by the dGPU (when coupled with the graphics interface 108) to provide a processed display signal. The display device 102 may then accordingly renders content on the display panel 110 based on the processed display signal. It should be noted that the removably coupled dGPU provides the graphical processing capabilities for the applications which would, otherwise, not be provided by the host computing system.

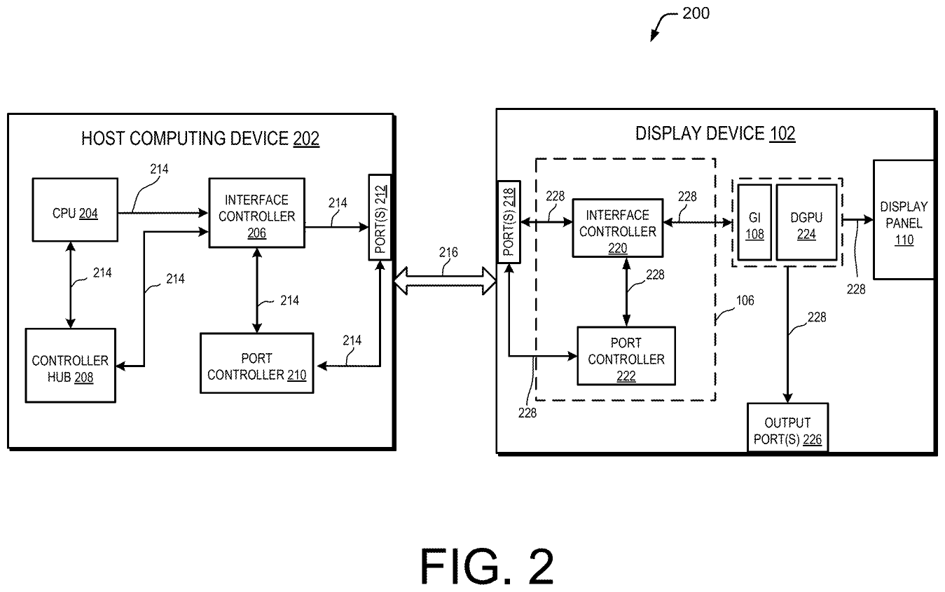

FIG. 2 depicts an example computing environment 200. The environment 200 further comprises a host computing system 202 which is externally coupled with the display device 102. In the context of the present subject matter, the host computing system 202 may be considered as any independently operating processor enabled device which performs one or more functions to generate output which is eventually to be rendered onto the display device 102. An example of such a host computing system 202 includes, but is not limited to, desktop computers, laptops, and portable computers. The present approaches may also be implemented in other types of host computing system 202 without deviating from the scope of the present subject matter. The host computing system 202 may be either a standalone device or in communication with other computing devices (not shown in FIG. 2) over a communication network

Continuing with the present example, the host computing system 202 may further include a central processing unit 204, an interface controller 206, and a controller hub 208. The host computing system 202 may further include a port controller 210 in communication with one or more interface port(s) 212. It may be noted that FIG. 2 depicts the various components as directly connected with each other through a series of interconnects 214, only for ease of illustration. The components may be connected either directly or indirectly, without deviating from the scope of the present subject matter.

The host computing system 202 is further coupled to the display device 102 through a connecting medium 216 between the interface ports, e.g., port(s) 212 of the host computing system 202 and port(s) 218 provided on the display device 102. In an example, the port(s) 212 and the port(s) 218 may be Thunderbolt™ 3 complaint, in which case the connecting the medium 216 may be Thunderbolt™ 3 complaint cable. Returning to the display device 102, the control circuitry 106 may further include an interface controller 220, and a port controller 222. In an example, the interface controller 220 is similar to the interface controller 206 of the host computing system 202, and the port controller 222 is similar to the corresponding port controller 210 of the host computing system 202. The port controllers 210, 222 may control the manner in which the respective port(s) 212 and port(s) 218 operate. The port(s) 212, 218 may support multiple protocols that govern functions pertaining to connection, communication and power supply of the host computing system 202 and the display device 102. For example, in cases where the port(s) 212, 218 are Thunderbolt™ 3 complaint, the port(s) 212, 218 may be used for purposes of powering either of the display device 102 and the host computing system 202, or for providing connection. Thunderbolt™ 3 complaint ports may allow USB-C type connectors which may be connected for a variety of purposes. The function for which the port(s) 212, 218 are being used may be detected, and controller by the respective port controllers 210, 222.

The display device 102 may further include a dGPU 224 which is removably coupled to the graphics interface 108. Since the dGPU 224 is removably coupled to the graphics interface 108, the dGPU 224 may be removed with minimal efforts and may be upgraded. In an example, the graphics interface 108 may further include slots into which the dGPU 224 may be inserted. In a similar manner, the dGPU 224 may be removed by manually removing the dGPU 224 from the slots.

In operation, the host computing system 202 (which is externally coupled to the display device 102) may generate one or more source display instructions. The source display instructions may be generated by the CPU 204 in response to the execution of one or more applications that may be installed on the host computing system 202. The source display instructions may include information based on which the visual output is rendered on the display panel 110 of the display device 102. Examples of such display instructions include, but is not limited to, information pertaining to processing of pixels, texture, rendering layers, shading, and the like. Once generated, the controller hub 208 directs the source display instructions to the interface controller 206. At this stage, the interface controller 206 may further determine the pertinent protocol which is supported by the port(s) 212. In an example, information pertaining to protocol being supported by the port(s) 212 may be obtained from the port controller 210. Based on the information received from the port controller 210, the interface controller 206 may accordingly convert the source display instructions into a format which conforms to the protocol supported by the port(s) 212.

The converted source display instructions (referred to as the converted instructions) may then be transmitted to the display device 102 through the medium 216. The converted instructions are received by the display device 102 at the port(s) 218. In an example, the port controller 222 directs the received source display instructions to the interface controller 220. The interface controller 220 on receiving the source display instructions converts them into a format which is processable by the dGPU 224. The source display instructions thereafter may be provided to the graphics interface 108, and to the dGPU 224 for further processing.

The dGPU 224 on receiving the source display instructions processes the same to generate a processed display signal. The dGPU 224 may perform a variety of graphical processing operations for generating the processed display signal. For example, the dGPU 224 may perform one or more geometric calculations to provide a graphical representation for rendering on the display panel 110. Additionally, the dGPU 224 may perform pixel processing, processing related to rendering of layer, shading, texturing, and so on, to provide the processed display signal which represents the visual representation of the content which is to be rendered onto the display panel 110. In an example, the dGPU 224 may further include a video memory (not shown in FIG. 2) which momentarily stores the information within the processed display signal. Based on such information from the video memory, frame of images (i.e., visual content) may be generated and retained within a frame buffer. The digital image may be further converted into an analog form for displaying on the display panel 110 of the display device 102.

It may be noted that the aforesaid examples are only a few of the many other processing examples that the dGPU 224 may implement to generate the processed display signal. The processed display signal may then be provided to the display panel 110 based on which the visual content may be rendered.

In an example, the processed display signal may also be provided to one or more of the output display port(s) 226. The processed display signal may be provided to the output display port(s) 226 along with rendering the visual content onto the display panel 110 of the display device 102. Each of the components within the display device 102 may be connected (either directly or indirectly) through interconnects 228. For example, the output display port(s) 226 may be coupled to an additional display monitor or a visual output device. This may allow a user to either ‘extend’ the screen of the display panel 110 to the additional display monitor, or may allow the content being rendered on the display panel 110 may be mirrored or replicated on the additional monitor which is coupled to output display port(s) 226.

The display device 102 as described allows switching the dGPU 224 to another dGPU having more advanced specifications with ease. Furthermore, such enhanced graphical processing capabilities may be achieved without the use of an eGPU module or without upgrading the host computing system 202, which may be not be possible when the host computing system 202 is a small form-factor computing system.

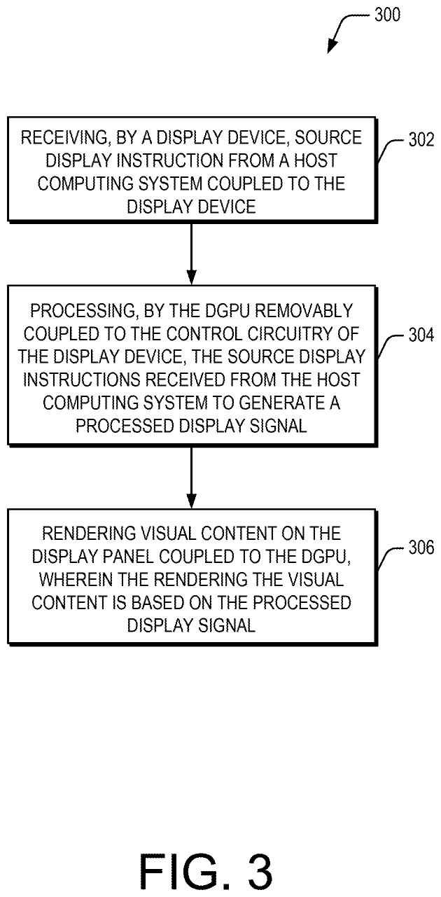

FIG. 3 illustrate example method 300, implemented by an example display device with a graphic interface for removably coupling a discrete graphics processing unit to the control circuitry of the example display device. The order in which the method is described is not intended to be construed as a limitation, and any number of the described method blocks may be combined in any order to implement the methods, or an alternative method. Furthermore, method 300 may be implemented within any other example display devices either through any suitable hardware or combination of hardware and non-transitory machine-readable instructions.

The method 300 may be implemented within one or more display device, such as the display device 102 as depicted in FIGS. 1-2. The method 300 are described below with reference to display device 102, as described above; other suitable systems for the execution of these methods may also be utilized. Additionally, implementation of these methods is not limited to such examples.

At block 302, source display instructions are received, from an externally coupled host computing system, by the display device to which the host computing system is coupled. The display device, in turn, includes a dGPU which is removably coupled to the control circuitry of the display device. For example, the display device 102 may be coupled to a host computing system 202. The host computing system 202 may generate one or more source display instructions as a result of execution of one or more applications running on the host computing system 202. In an example, the source display instructions may include information based on which the visual output is rendered on the display panel 110 of the display device 102.

At block 304, the dGPU which is removably coupled to the control circuitry of the display device, processes the source display instructions received from the host computing system to generate processed display signals. For example, the dGPU 224 on receiving the source display instructions may perform a variety of graphical processing operations which may include operations relating to pixel processing, processing related to rendering of layer, shading, texturing, and so on. In an example, the source display instructions may be in format which conforms to a protocol supported by the connecting port(s) 212, 218 and the medium 216. In such cases, the display device 102 may further include an interface controller 220 which converts the source display instructions into a format which is processable by the dGPU 224.

At block 306, visual content corresponding to the processed display signal is rendered onto the display panel of the display device. For example, the dGPU 224 includes a video memory within the control circuitry 106 of the display device 102. The video memory may be used for momentarily storing the information within the processed display signal. Based on such information from the video memory, frame of images (i.e., visual content) may be generated and retained within a frame buffer. The digital image may be further converted into an analog form for displaying on the display panel 110 of the display device 102.

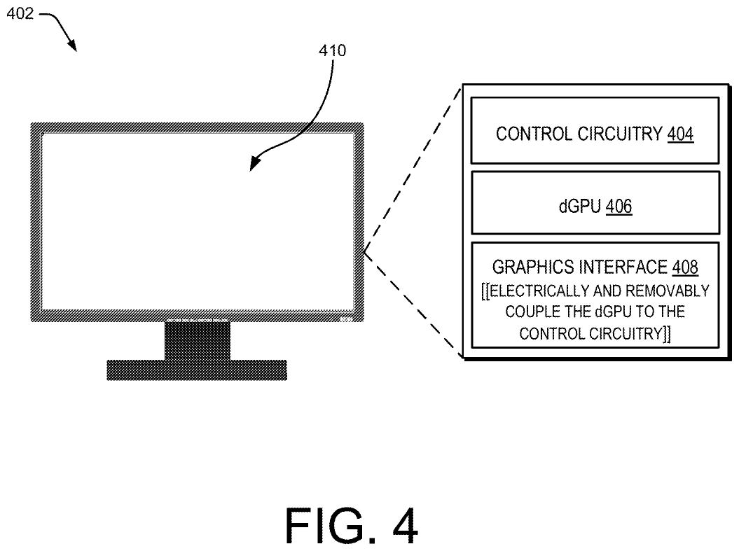

FIG. 4 illustrates another example of a digital display device, e.g., the display device 402 which includes a removably coupled dGPU. The display device 402 may be any display device for rendering and displaying output generated by a host computing system, such as a host computing system 202, which in turn is externally coupled to the display device 402. The display device 402, as per the present example includes, but is not limited to, a display monitor, display devices such as LCD displays, LED displays, Plasma Displays, OLED displays, or a digital projector. The aforementioned examples are only illustrative. Other examples of display devices may also be possible without deviating from the scope of the present subject matter.

In an example, the display device 402 comprises control circuitry 404 which is to control operations of the display device 402. In another example, the control circuitry 404 may implement one or more functionalities related to graphical processing. The display device 402 further includes a dGPU 406 and a graphics interface 408. In an example, the dGPU 406 is a Mobile PCI Express Module (MXM) based graphics module which is removably coupled to the control circuitry 404. The graphics interface 408 removably couples the dGPU 406 to the control circuitry 404 of the display device 402. In addition to coupling the dGPU 406 to the control circuitry 404, the graphics interface 408 is additionally coupled to a display panel 410 of the display device 402.

In operation, the display device 402 may be externally coupled to host computing system, such as the host computing system 202 (depicted in FIG. 2) from which the display device receives one or more source display instructions. The source display instructions received from the host computing system are obtained, and provided to the dGPU 406. The dGPU 406 may accordingly process the source display instructions to generate a processed display signal. The display device 402 may then accordingly render content on the display panel 410 based on the processed display signal. It should be noted that the removably coupled dGPU provides the graphical processing capabilities for the applications which would, otherwise, not be provided by the host computing system, such as the host computing system 202. Any enhanced graphical processing capabilities may achieve by replacing the removably coupled dGPU 406 from the display device 402, and installing a dGPU with desired hardware specifications.

Although examples for the present disclosure have been described in language specific to structural features and/or methods, it should be understood that the appended claims are not necessarily limited to the specific features or methods described. Rather, the specific features and methods are disclosed and explained as examples of the present disclosure.

We claim:

1. A display device comprising:
control circuitry to control operation of the display device, wherein the control circuitry is to receive source display instructions from a host computing system operating independently from the display device, wherein control circuitry is to externally couple the host computing system to the display device;
a graphics interface to electrically and removably couple a discrete graphics processing unit (dGPU) to the control circuitry;
a display panel coupled to the control circuitry and the graphics interface, wherein the display panel is to render visual information based on a processed display signal, wherein the processed display signal is generated, by the dGPU when coupled to the graphics interface, based on processing the source display instructions; and
a housing, wherein the housing encloses the control circuitry, the graphics interface and the display panel.

2. The display device as claimed in claim 1, further comprising an interface controller, wherein the interface controller is to:
receive the source display instructions transmitted by the host computing system; and
convert the source display instructions transmitted by the host computing system to a format processable by the dGPU, wherein the dGPU is to generate the processed display signal based on the converted source display instructions.

3. The display device as claimed in claim 1, wherein the graphics interface is based on one of PCI Express (Peripheral Component Interconnect Express) bus standard and Mobile PCI Express Module (MXM) standard.

4. The display device as claimed in claim 1, further comprising an interface port to connect with the host computing system wherein the interface port supports a plurality of protocols to govern functions pertaining to connection, communication and power supply of the device.

5. The display device as claimed as claimed in claim 4, further comprising a port controller coupled to the interface port, wherein the port controller is to:
detect whether a connection with the host computing system has been established through the interface port; and
based on the established connection, control functions pertaining to communication with the host computing system through the interface port.

6. The display device as claimed in claim 1, further comprising an output display port coupled to the dGPU, wherein the output display port is to receive the processed display signal from the dGPU.

7. The display device as claimed in claim 6, wherein the output display port is one of HDMI (High-Definition Multimedia Interface) port, DisplayPort, and Video Graphics Array (VGA) port.

8. A method comprising:
receiving, by a display device, source display instructions from an independently operating host computing system externally coupled to the display device, the display device comprising:
a discrete graphics processing unit (dGPU) removably coupled to control circuitry of the display device; and
a display panel coupled to the dGPU;
processing, by the dGPU removably coupled to the control circuitry of the display device, the source display instructions received from the host computing system to generate a processed display signal; and
rendering visual content on the display panel coupled to the dGPU, wherein rendering the visual content is based on the processed display signal.

9. The method as claimed in claim 8, wherein the dGPU is electrically coupled to the control circuitry of the display device through a graphics interface.

10. The method as claimed in claim 8, wherein the receiving the source display instructions further comprises:
detecting, at interface port of the display device, the source display instructions from the host computing system; and
directing the source display instructions to an interface controller within the display device; and
converting the source display instructions to a converted instructions format processable by the dGPU.

11. The method as claimed in claim 10, further comprising processing the converted instructions format by the dGPU to generate the processed display signal.

12. The method as claimed in claim 8, wherein the dGPU is removably coupled to the control circuitry based on one of PCI Express (Peripheral Component Interconnect Express) standard and Mobile PCI Express Module (MXM) standard.

13. The method as claimed in claim 8, wherein the host computing system is an independently operating small form-factor personal computer.

14. A display device comprising:
control circuitry to control operation of the display device control, wherein the control circuitry is to receive source display instructions from a host computing system operating independently from the display device, wherein control circuitry is to externally couple the host computing system to the display device;
a discrete graphics processing unit (dGPU);
a graphics interface to electrically and removably couple the dGPU to the control circuitry;
a display panel coupled to the graphics interface, wherein the display panel is to,
receive a processed display signal generated by the dGPU based on processing the source display instructions; and
render visual content based on the processed display signal.

15. The display device as claimed in claim 14, wherein the dGPU is a Mobile PCI Express Module (MXM) based graphics module.
